(19) United States
(12) Patent Application Publication
(10) Pub. No.: US 2012/0139480 A1
(43) Pub. Date: Jun. 7, 2012

(54) CHARGER AND CHARGING SYSTEM

(75) Inventor: Satoshi KANEKO, SAITAMA (JP)

(73) Assignee: HONDA MOTOR CO., LTD., TOKYO (JP)

(21) Appl. No.: 13/155,474

(22) Filed: Jun. 8, 2011

(30) Foreign Application Priority Data
Jun. 8, 2010 (JP) 2010-130674

(51) Int. Cl. H02J 7/00

(52) U.S. Cl. 320/107

(57) ABSTRACT

In a charger for charging a storage battery provided in a load, electric power derived from an external source is converted by a first electric power converter, and stored in an internal battery. A monitoring device is provided to monitor a charge status of the internal battery. An internal battery charge controller is configured to regulate electric power from the first electric power converter to the internal battery based upon the charge status of the internal battery being monitored by the monitoring device. An output power controller is configured to regulate electric power supplied from the internal battery through a connector to the storage battery.

### CROSS-REFERENCE TO RELATED APPLICATION(S)

This application claims priority from Japanese Patent Application No. 2010-130674 filed on Jun. 8, 2010, the disclosure of which is incorporated herein by reference in its entirety.

### BACKGROUND

The present invention relates to a charger for charging a storage battery and a charging system.

A charger for quickly charging a storage battery is known in the art (see JP 2004-79316 A). In this charger, to realize quick charging, a large-capacity utility power is required.

However, the introduction and maintenance of the large-capacity utility power supply involve great expense, and thus there is a need to realize quick charging even with a small-capacity power.

### SUMMARY

It is one aspect of various embodiments of the present invention to provide a charger and a charging system in which quick charging is realized with a small-capacity power derived from an external source.

More specifically, according to one or more embodiments, a charger for charging a storage battery provided in a load is disclosed, which comprises a first electric power converter, an internal battery, a monitoring device, an internal battery charge controller, a connector, and an output power controller. The first electric power converter is configured to convert electric power derived from an external source. The internal battery is configured to store electric power outputted from the first electric power converter. The monitoring device is configured to monitor a charge status of the internal battery. The internal battery charge controller is configured to regulate electric power from the first electric power converter to the internal battery based upon the charge status of the internal battery being monitored by the monitoring device. The connector is configured to provide a connection for the storage battery. The output power controller is configured to regulate electric power supplied from the internal battery through the connector to the storage battery.

With this configuration, electric power outputted from the first electric power converter can be stored in the internal battery; therefore, even if the capacity of the external power source is small, quick charging of the storage battery can be realized by making use of a large amount of electric power available from the internal battery.

The first electric power converter may include an AC-to-DC converter to convert alternating current into direct current.

With this additional feature, in a case where the external power source includes an alternating-current power source, charging of the internal battery can be performed effectively under conditions conformable to the internal battery.

The first electric power converter may include a DC-to-DC converter to convert one direct-current voltage into another.

With this additional or alternative feature, in a case where the external power source includes a direct-current power source, charging of the internal battery can be performed effectively under conditions conformable to the internal battery.

One or more embodiments of the charger as described above may further comprise a second electric power converter configured to convert the electric power supplied from the internal battery to the storage battery, wherein the second electric power converter includes a DC-to-DC converter to convert one direct-current voltage into another.

With this additional feature, the voltage for charging the storage battery can be converted by the second electric power converter; therefore, charging of the storage battery can be performed effectively with a voltage conformed to the storage battery.

One or more embodiments of the charger as described above may further comprise at least one other internal battery configured to store electric power outputted from the first electric power converter, an upstream connection switch configured to permit a connection between each of the internal batteries and the first electric power converter to be selectively interrupted, and a downstream connection switch configured to permit a connection between each of the internal batteries and the storage battery to be selectively interrupted.

With these configurations, when one internal battery is exhausted during charging the storage battery, the downstream connection switch may be operated appropriately to cause the connection with the storage battery to be switched from the one internal storage battery to another fully charged internal battery. Moreover, the upstream connection switch may be operated appropriately to cause the connection between the exhausted internal battery and the first electric power converter to be established. In this way, charging of the internal battery can be performed effectively.

In another aspect, a charging system consistent with the present invention is provided which comprises a charger described above and a storage battery disconnectably connected toe the connector.

### BRIEF DESCRIPTION OF THE DRAWINGS

The above aspects and advantages, other advantages and further features of the present invention will become more apparent by describing in detail illustrative, non-limiting embodiments thereof with reference to the accompanying drawings, in which:

FIG. 1 is a schematic diagram showing a charging system according to one illustrative embodiment of the present invention; and

FIG. 2 is a schematic diagram showing a charging system according to another embodiment in which only one internal battery is provided.

### DETAILED DESCRIPTION OF THE EMBODIMENTS

A detailed description will be given of an illustrative embodiment of the present invention with reference to the drawings.

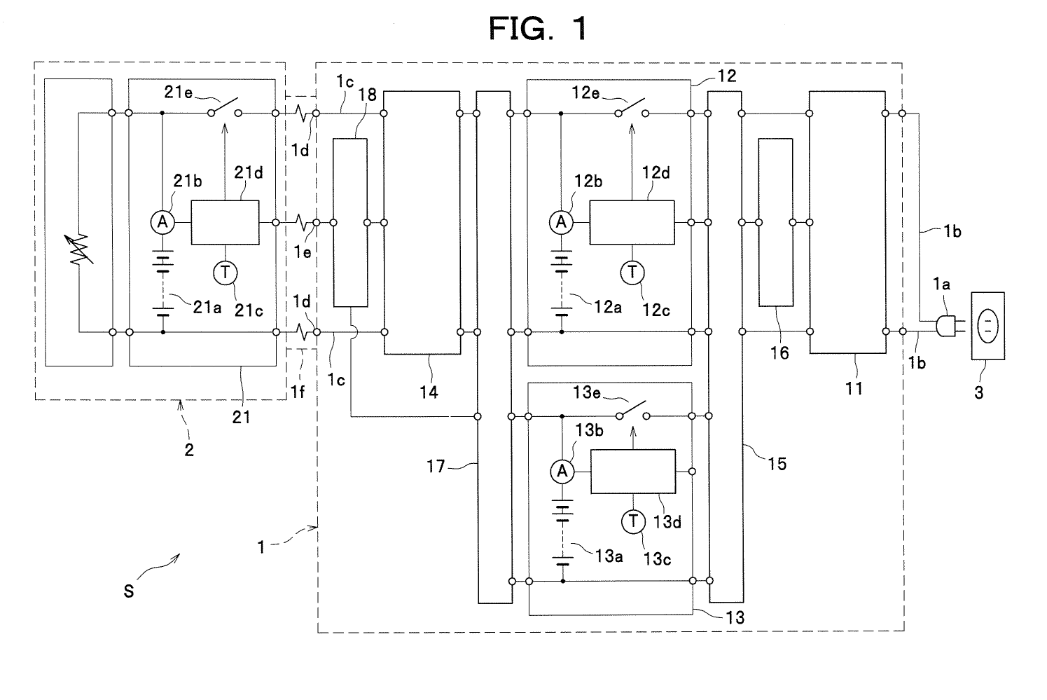

As shown in FIG. 1, a charging system S includes a charger 1 and a storage battery 21a provided in an autonomous mobile robot 2 as an example of a load.

A charger 1 principally includes an AC-to-DC converter 11 as an example of a first electric power converter, two internal battery units 12, 13, and a DC-to-DC converter 14 as an example of a second electric power converter.

The AC-to-DC converter 11 is a device configured to convert electric power derived from a utility power supply 3 as an example of an external source, from alternating current into direct current. When a plug 1a equipped in the charger 1 is inserted into a receptacle (i.e., the charging system S is connected to the utility power supply 3), electric power is supplied from the utility power supply 3 through the plug 1a and electric wiring 1b to the AC-to-DC converter 11. The AC-to-DC converter 11 is connected through an upstream connection switch 15 to internal batteries 12a, 13a in internal battery units 12, 13. Electric power outputted from the AC-to-DC converter 11 to each of the internal batteries 12a, 13a is regulated by an upstream output power control board 16 as an example of an internal battery charge controller.

The upstream connection switch 15 is a switch configured to permit a connection between each of the internal batteries 12a, 13a and the AC-to-DC converter 11 to be selectively interrupted. To be more specific, in this embodiment, the upstream connection switch 15 is configured to interrupt the electric power output from the AC-to-DC converter 11 to either one of the internal batteries 12a, 13a while maintaining the electric power therefrom to the other of the internal batteries 12a, 13a.

The internal battery unit 12 includes an internal battery 12a, a current sensor 12b, a temperature sensor 12c, an internal battery management board 12d, and a charge interruption switch 12e. The current sensor 12b, temperature sensor 12c and internal battery management board 12d constitute a monitoring device. Since two internal battery units 12, 13 have the same configuration, the following description will be directed only to the internal battery unit 12, and a duplicate description in relation to the internal battery unit 13 of which like elements are designated by the corresponding reference characters (13a, 13b, 13c, 13d and 13e) will be omitted. Similarly, a storage battery unit 21 provided in the autonomous mobile robot 2 has substantially the same configuration as that of the internal battery unit 12, and thus a duplicate description in relation to the storage battery unit 21 of which like elements are designated by the corresponding reference characters (21a, 21b, 21c, 21d and 21e) will be omitted.

The internal battery 12a is configured to be charged from the utility power supply 3 through the AC-to-DC converter 11. As the internal battery 12a, for example, a lithium-ion battery, or a nickel metal hydride battery can be adopted. The capacity of the internal battery 12a is preferably larger than that of the storage battery 21a. The internal battery 12a preferably has more cells (i.e., higher voltage) than the storage battery 21a.

In a conventional configuration where the storage battery is charged directly from the utility power supply, the capacity of current is limited to a specific value conforming to its wiring specification, so that quick charging cannot be realized; on the other hand, in the configuration according to the present embodiment described above, electric power stored in the internal battery 12a can be supplied to the storage battery 21a, so that a large-capacity current can be supplied thereto and thus a time for charging can be shortened.

The current sensor 12b is a sensor configured to detect a current from the internal battery 12a and obtain a current value, and the thus-obtained current value is provided to the internal battery management board 12d. The temperature sensor 12c is a sensor configured to detect a temperature of the internal battery 12a and obtain a temperature value, and the thus-obtained temperature value is provided to the internal battery management board 12d.

The internal battery management board 12d is a circuit board configured to monitor or manage information (current and temperature values) obtained from the current sensor 12b and the temperature sensor 12c, and various data calculated from the information obtained from these sensors 12b, 12c, such as the charge status of the internal battery 12a calculated from the information provided by the current sensor 12b. The internal battery management board 12d outputs the information on the charge status of the internal battery 12a to the upstream output power control board 16. The internal battery management board 12d is configured to determine whether or not the internal battery 12a has been fully charged, based upon information from the current sensor 12b. If the internal battery management board 12d determines that the internal battery 12a has been fully charged, the internal battery management board 12d activates the charge interruption switch 12e provided between the internal battery 12a and the AC-to-DC converter 11, to interrupt the current supplied to the internal battery 12a. This process of control exercised by the internal battery management board 12d serves to prevent the internal battery 12a from being overcharged.

In addition, the internal battery management board 12d is configured to determine whether or not the temperature of the internal battery 12a has been a predetermined level or higher, based upon information from the temperature sensor 12c. If the internal battery management board 12d determines that the temperature of the internal battery 12a has been the predetermined level or higher, the internal battery management board 12d activates the charge interruption switch 12e, to interrupt the current supplied to the internal battery 12a. This process of control exercised by the internal battery management board 12d serves to prevent the internal battery 12a from overheating.

The upstream output power control board 16 is configured to regulate electric power supplied from the AC-to-DC converter 11 to the internal batteries 12a, 13a to levels (voltage, current) suitable for charging of the internal batteries 12a, 13a, based upon information (the charge statuses of the internal batteries 12a, 13a) outputted from the internal battery management boards 12d, 13d. To be more specific, for example, the upstream output power control board 16 raises the voltage applied by the AC-to-DC converter 11 to a level higher than 100 V (the voltage of the utility power supply 3), and regulates the current to specific levels conformable to the charge statuses of the internal batteries 12a, 13a.

The upstream output power control board 16 is also configured to control the switching operation of the upstream connection switch 15 based upon the charge statuses of the internal batteries 12a, 13a. To be more specific, for example, the upstream output power control board 16 exercises a control such that when the charge status of the internal battery 12a exhibits a predetermined level or lower (i.e., running-down state), the connection between the internal battery 12a and the AC-to-DC converter 11 is established, while the connection between the internal battery 13a (not in the running-down state) and the AC-to-DC converter 11 is interrupted. This process of control of the upstream output power control board 16 serves to efficiently charge the internal battery 12a (i.e., immediately when it runs down).

The DC-to-DC converter 14 is a device configured to convert electric power supplied from the internal batteries 12a, 13a to the storage battery 21a (to convert its voltage from one direct-current voltage into another). To be more specific, the DC-to-DC converter 14 steps down the voltage supplied from the internal batteries 12a, 13a and outputs a lower voltage to the storage battery 21a. The DC-to-DC converter 14 is connected through a downstream connection switch 17 to each of the internal batteries 12a, 13a, and connected through wires 1c and terminals 1d to a storage battery unit 21 of the autonomous mobile robot 2. Electric power outputted from the DC-to-DC converter 14 is regulated by a downstream output power control board 18 as an example of an output power controller.

The downstream connection switch 17 is a switch configured to permit a connection between each of the internal batteries 12a, 13a and the storage battery 21a to be selectively interrupted. To be more specific, in this embodiment, the downstream connection switch 17 is configured to interrupt the electric power supplied from either one of the internal batteries 12a, 13a to the storage battery 21a while maintaining the electric power from the other one of the internal batteries 12a, 13a thereto.

The downstream output power control board 18 is configured to regulate electric power supplied from the internal batteries 12a, 13a to the storage battery 21a. The downstream output power control board 18 exercises control under which a switch (not shown) is turned ON or OFF to cause the electric power from the internal batteries 12a, 13a to be supplied to the storage battery 21a or interrupted, and the DC-to-DC converter 14 is caused to convert the electric power outputted from the internal batteries 12a, 13a into a level suitable for charging of the storage battery 21a.

To be more specific, the downstream output power control board 18 is connected through the terminal 1e to the storage battery management board 21d. In this embodiment, the charger 1 includes a connector 1f having the terminal 1e and the aforementioned terminals 1d provided in pair. To this connector 1f, the storage battery unit 21 of the autonomous mobile robot 2 is disconnectably connected.

The downstream output power control board 18 is configured to regulate electric power outputted from the DC-to-DC converter 14 based upon the charge status of the storage battery 21a outputted from the storage battery management board 21d, to make the electric power supplied therefrom to the storage battery 21a greater than the electric power outputted from the utility power supply 3. To be more specific, in this embodiment, the downstream output power control board 18 is configured to regulate the electric power outputted from the DC-to-DC converter 14, so that the electric power reaches a level greater as described above and the voltage and the current become suitable for quick charging of the storage battery 21a (i.e., conformable to the charge status of the storage battery 21a).

To give an example, the downstream output power control board 18 in this embodiment is configured to regulate the electric power outputted from the DC-to-DC converter 14 so that the voltage is lower than 100V (the voltage of the utility power supply 3), the electric current value is higher than 15 A (the current value of the utility power supply 3), and the electric power is greater than 1,500 W (the electric power of the utility power supply 3). With this configuration, in which the storage battery 21a is charged through the DC-to-DC converter 14 from the internal batteries 12a, 13a, the storage battery 21 can be charged with electricity of a more stable power and a larger amount of current in comparison with the configuration in which the storage battery is charged directly from the utility power supply.

The downstream output power control board 18 is also configured to control the switching operation of the downstream connection switch 17 based upon the charge status of the storage battery 21a. To be more specific, for example, suppose that the downstream output power control board 18 is exercising control over the downstream connection switch 17 so as to maintain connection between one of the internal batteries 12a, 13a and the storage battery 21a, if it is determined that the charge status of one of the internal batteries 12a, 13a (e.g., the internal battery 12a) exhibits a predetermined level or lower, then the connection between the internal battery 12a and the storage battery 21a is interrupted, while the connection between the other of the internal batteries 12a, 13a (e.g., the internal battery 13a) and the storage battery 21a is established. This process of control of the downstream output power control board 18 makes it possible to continuously charge the storage battery 21a with electricity supplied from the internal battery 13a even when the internal battery 12a currently supplying the electricity to the storage battery 21a runs down (i.e., the charge status thereof exhibits a predetermined level or lower; e.g., the internal battery 12a becomes dead or weak).

With the charging system S configured as described above in accordance with the present embodiment, the following advantageous effects may be exerted.

Since the internal batteries 12a, 13a can output electric power greater than the electric power outputted from the AC-to-DC converter 11, quick charging of the storage battery 21a can be realized with the greater electric power supplied from the internal batteries 12a, 13a even when the capacity of the utility power supply 3 is small.

During the charging of the storage battery 21a with electricity supplied from the internal battery 12a, even when the internal battery 12a runs down, the other internal battery 13a which may be fully charged can be connected to the storage battery 21a by the downstream connection switch 17 under control of the downstream output power control board 18. Furthermore, the internal battery 12a which has just run down can be connected to the AC-to-DC converter 11 at once by the upstream connection switch 15 under control of the upstream output power control board 16, and thus the internal battery 12a can be charged efficiently.

Moreover, the connections to the storage battery 21a and the AC-to-DC converter 11 can be switched, respectively, among a plurality of internal batteries 12a, 13a. Therefore, for example, when the storage batteries 21a of a plurality of autonomous mobile robots 2 are to be consecutively charged without intermission, a first storage battery 21a can be charged with electricity supplied from the fully-charged internal battery 12a and a second storage battery 21a can be charged with electricity supplied from the fully-charged internal battery 13a. In addition, the internal battery 12a which has finished charging the first storage battery 21a and thus become weak or dead can be recharged by establishing connection with the AC-to-DC converter 11 for a subsequent operation of charging of a third storage battery 21a, during the operation of charging of the second storage battery 21a with electricity supplied from the internal battery 13a.

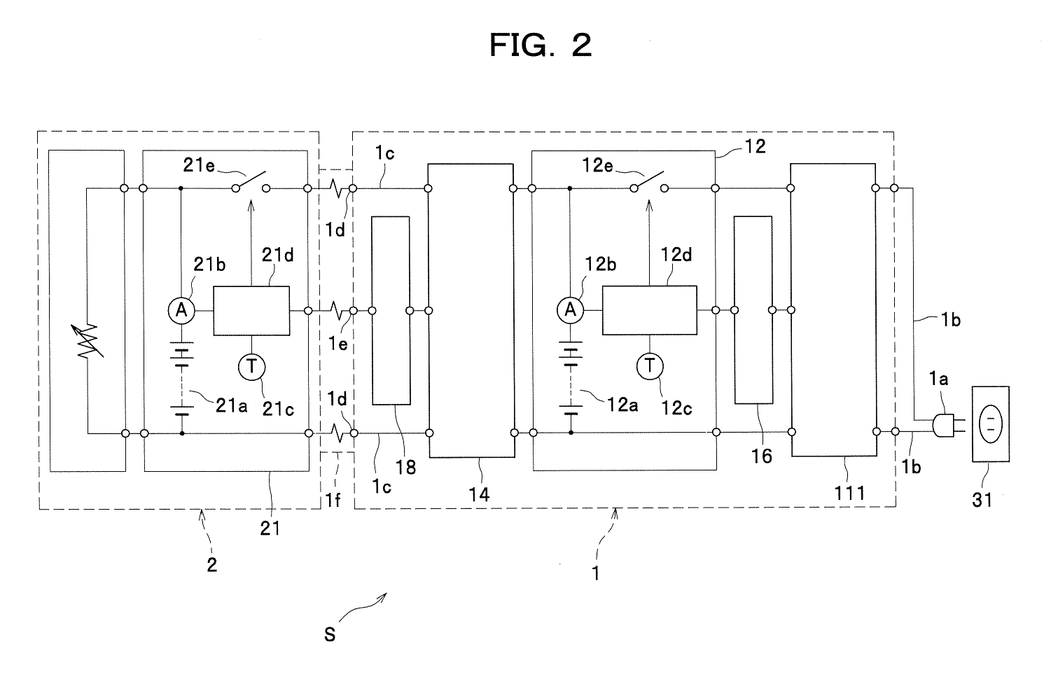

Although the exemplary embodiment of the present invention has been described above, the present invention is not limited to this embodiment, and may be carried out into practice in various other ways, as will be described below. In FIG. 2 which will be referred to in describing an alternative embodiment, the same elements will be designated by the same reference characters and a duplicate description will be omitted.

In the above-described embodiment, a plurality of internal batteries 12a, 13a are provided in the charging system S. However, the present invention is not limited to this specific configuration, and as shown in FIG. 2, the charger 1 may include only one internal battery 12a.

Additionally or alternatively, a DC-to-DC converter 111 to convert one direct-current voltage (of external power source) into another may be adopted as the first electric power converter, instead of the AC-to-DC converter 11. With this feature, in a case where the external power source is of a direct-current supplying type, the charging of the internal battery 12a can be performed effectively with electricity supplied from the DC-to-DC converter 111.

In the above-described embodiment, the autonomous mobile robot 2 is taken as an example of a load in which a storage battery to be recharged is provided. However, the present invention is not limited to this specific embodiment, and can be applied to a charger or a charging system for an electrically powered bicycle, an electric vehicle, and the like.

In the above-described embodiment, the monitoring device is composed of a current sensor 12b, a temperature sensor 12c and an internal battery management board 12d, but the present invention is not limited to this specific embodiment. For example, the monitoring device consistent with the present invention may be configured without a temperature sensor, and/or with a voltage sensor instead of the current sensor. In cases where the temperature sensor is omitted, the charge status of the internal battery may be calculated based only on information from the current sensor and the voltage sensor.

What is claimed is:

1. A charger for charging a storage battery provided in a load, the charger comprising:
a first electric power converter configured to convert electric power derived from an external source;
an internal battery configured to store electric power outputted from the first electric power converter;
a monitoring device configured to monitor a charge status of the internal battery;
an internal battery charge controller configured to regulate electric power from the first electric power converter to the internal battery based upon the charge status of the internal battery being monitored by the monitoring device;
a connector configured to provide a connection for the storage battery; and
an output power controller configured to regulate electric power supplied from the internal battery through the connector to the storage battery.

2. The charger according to claim 1, wherein the first electric power converter includes an AC-to-DC converter to convert alternating current into direct current.

3. The charger according to claim 1, wherein the first electric power converter includes a DC-to-DC converter to convert one direct-current voltage into another.

4. The charger according to claim 1, further comprising a second electric power converter configured to convert the electric power supplied from the internal battery to the storage battery, wherein the second electric power converter includes a DC-to-DC converter to convert one direct-current voltage into another.

5. The charger according to claim 1, further comprising:
at least one other internal battery configured to store electric power outputted from the first electric power converter;
an upstream connection switch configured to permit a connection between each of the internal batteries and the first electric power converter to be selectively interrupted; and
a downstream connection switch configured to permit a connection between each of the internal batteries and the storage battery to be selectively interrupted.

6. The charger according to claim 5, wherein the monitoring device is provided for each of the internal batteries to monitor a charge status of each of the internal batteries.

7. A charging system comprising:
a charger according to claim 1; and
a storage battery disconnectably connected to the connector.
